(19) United States
(12) Patent Application Publication
(10) Pub. No.: US 2012/0327242 A1
(43) Pub. Date: Dec. 27, 2012

(54) SURVEILLANCE CAMERA WITH RAPID SHUTTER ACTIVATION

(76) Inventors: Christopher B. Barley, Grand Prairie, TX (US); James Brandon Roach, Grand Prairie, TX (US)

(21) Appl. No.: 13/169,818

(22) Filed: Jun. 27, 2011

(51) Int. Cl. H04N 7/18

(52) U.S. Cl. 348/155; 348/152; 348/E07.085

(57) ABSTRACT

A surveillance camera has plural triggering sensors that sense moving objects. A secondary sensor senses the object first, and wakes up the processor in the camera so that when the object is sensed by a main sensor, the processor is ready to take the picture immediately.

### FIELD OF THE INVENTION

The present invention relates to cameras that are used to scout or surveil areas for wildlife, security, people, etc.

### BACKGROUND OF THE INVENTION

Cameras can be used to scout or surveil wildlife. For example, a camera is set up near a game trail, feeder, watering hole or other area where wildlife pass or gather on a frequent basis. The camera is mounted to a tree, post, etc. It has a sensor to detect the presence of wildlife. Thus, the camera automatically takes pictures when wildlife are detected. The automatic operation of the camera is useful because a human operator need not monitor the camera for long periods of time in order to operate it. Also, there is no human operator present which might repel wildlife.

These cameras are known as game scouting cameras or trail cameras. The cameras can be film or digital and can take still pictures or movies (video). The cameras can also be equipped with a flash. The flash can be of white light, infrared light or a camera may have both types of flashes.

The earliest cameras used to scout wildlife were believed to be conventional cameras mounted in housings to protect the camera from the weather. As scouting cameras have evolved, the cameras are specifically designed units for the particular task.

Surveillance or security cameras are used to observe an area. For example, on a construction site, cameras may be used to deter theft of equipment. Also, a surveillance camera can be used to monitor people, such as a baby or a baby sitter.

Surveillance cameras that use a sensor to detect motion and trigger the camera encounter lag times from when the sensor detects something to when the camera shutter is activated to take a picture. It is desirable to shorten this lag time.

### SUMMARY OF THE INVENTION

A surveillance camera comprises a lens, a memory, an image sensor and a processor that processes information from the image sensor. The processor operates in a sleep mode, wherein the processor cannot process information from the image sensor, and a wake mode, wherein the processor can process information from the image sensor. First and second triggering sensors each have a detection area. The first triggering sensor detection area is located in front of the lens. The second triggering sensor detection area is located adjacent to the first triggering sensor detection area. When the second triggering sensors senses an object moving in its detection area it causes the processor to enter the wake mode. When the first triggering sensor senses an object moving in its detection area, it causes the processor to capture and process an image.

In accordance with one aspect, the second triggering sensor detection area is located to a side of the first triggering sensor detection area.

In accordance with another aspect, a third triggering sensor has a third detection area located to another side of the first triggering sensor detection area. When the third triggering sensors senses an object moving in its respective detection area, the third triggering sensor causes the processor to enter the wake mode.

In accordance with still another aspect, the first, second, and third triggering sensors are each passive infrared sensors.

There is also provided a method of taking images with a surveillance camera. First and second triggering sensors are provided, with each having a respective detection area. A processor is provided that can process images. The processor is operated in a sleep mode. An object entering the second triggering sensor detection area is detected, where upon the operation of the processor is changed from the sleep mode to a wake mode. The object is detected entering the first triggering sensor detection area, where upon an image is taken and the image is processed with the processor.

### BRIEF DESCRIPTION OF THE DRAWINGS

FIG. 1 shows a front view of the surveillance camera.

FIG. 2 shows a perspective view of the camera on a support structure.

FIG. 3 shows a block diagram of the camera.

FIG. 4 illustrates an arrangement of plural triggering sensors and the operation of the camera.

### DESCRIPTION OF THE PREFERRED EMBODIMENTS

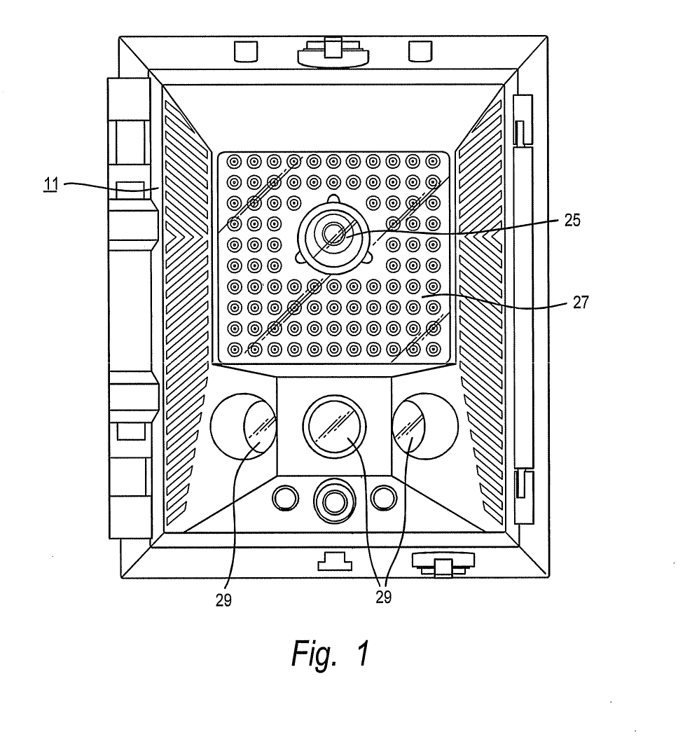

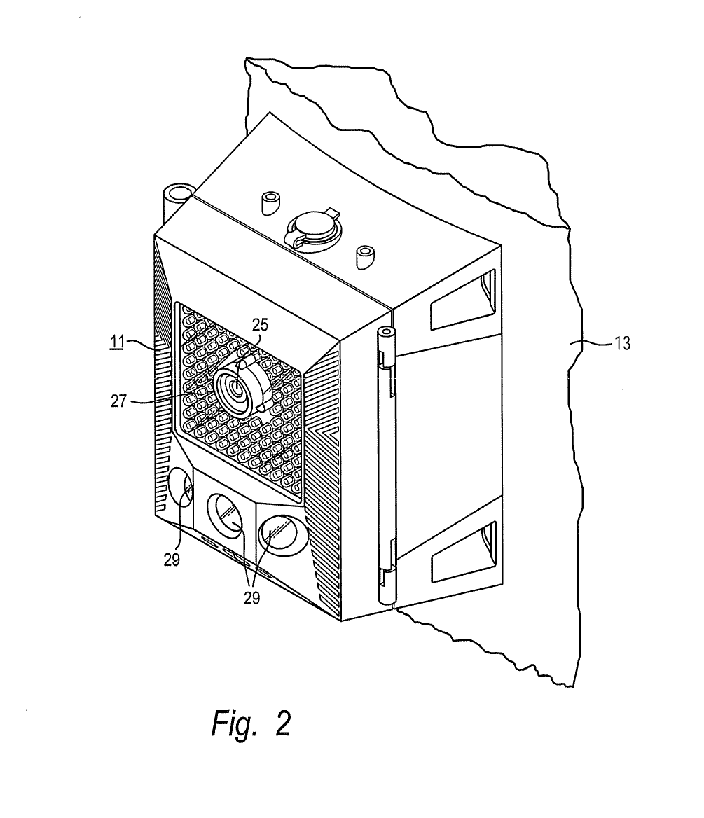

FIGS. 1 and 2 show a surveillance camera 11. In the preferred embodiment, the camera is designed to be located outdoors, such as on a tree 13, post, etc. The camera 11 can also be used to surveil other areas such as construction sites (indoors or outdoors), warehouses, offices, homes, baby nurseries, etc. The camera 11 is automatically operated, taking pictures and/or video and storing the pictures or video. As used herein, “pictures” or “images” means still pictures and video, which is moving pictures with or without audio, and also means audio alone, such as contained in sound files. The image data is stored in memory for later access and use. Alternatively, the image data can be streamed to a location other than the camera, for example, a live video feed can be provided by the camera to an offsite, or remote, location.

Once the camera 11 is installed, it typically is left in place, and the picture or image data is removed from the camera for viewing. The camera is kept in place and operational so as to continue to take pictures. The picture or image data can be removed from the camera 11 by various techniques such as storing the images on a memory card and removing the card from the camera to be read by another device (such as a handheld camera, a personal computer, etc.)

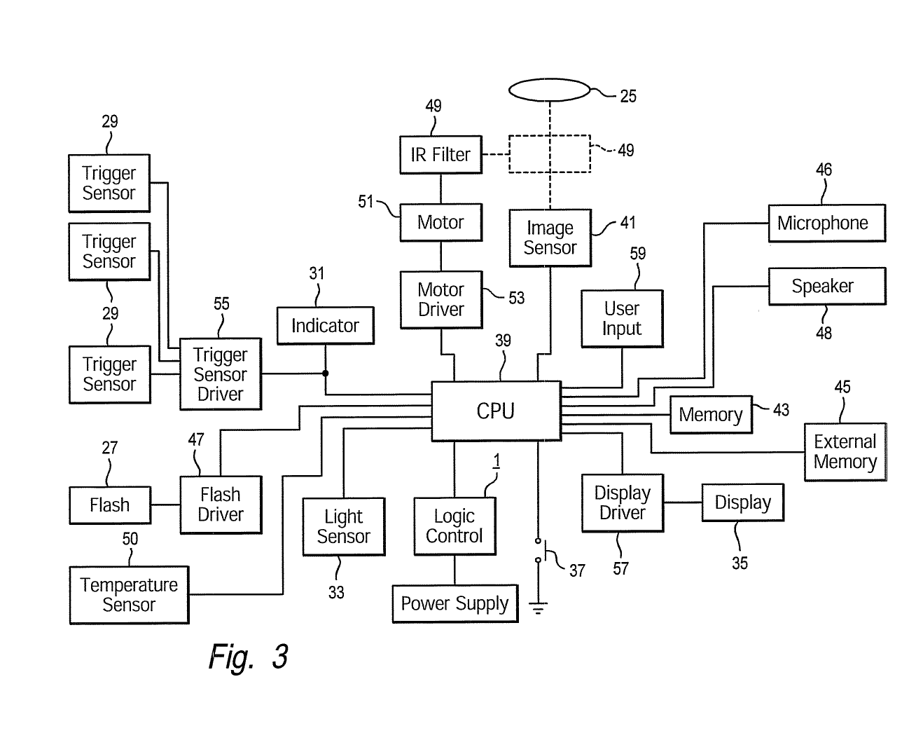

The components of the camera 11 will now be described. Referring to FIG. 2, the camera has a lens 25, a flash assembly 27 and plural triggering sensors 29. The camera also has electronics, shown in FIG. 3. A central processing unit (CPU) 39 is provided. In the preferred embodiment, the CPU incorporates features of an image and/or a video processor. An image sensor 41 provides inputs to the CPU. The image sensor 41 can be a CCD or a CMOS type sensor. The image sensor is located behind the lens 25. Memory 43 is connected to the CPU 39. The memory 43 can be NAND flash memory, STRAM memory or a combination thereof, or some other type of memory. In addition, removable memory devices 45 such as memory cards, can be used. Memory cards are referred to as external memory. The memory card 45 is inserted into a slot in the camera. The camera can have solely on board (non-removable) memory, solely removable memory, or a combination of the two. The CPU 39 processes the data from the image sensor 41 and stores the image data in memory 43, 45. The lens 25, image sensor 41, CPU 39 and memory 43 make up the major image-taking components of the camera. The camera described herein is a digital camera. The camera can take still photographs or video. A microphone 46 is provided to pick up sound for the video. A speaker 48 is provided for messages, playback, etc.

The camera can take pictures in daylight and also in lowlight conditions, such as night, using the flash 27. In the preferred embodiment, the flash is an infrared flash, a white light flash, or a combination of the two. The flash 27 is provided by a series of LED's, which are powered by a flash driver 47. The flash driver is connected to the CPU 39. A light sensor 33, typically located on the outside of the camera, provides measurement of ambient light so as to all the CPU 39 to determine which flash (IR or white light) to use.

An infrared filter 49 is removably provided between the lens 25 and the image sensor 41. In daylight conditions, the infrared filter 49 is located in front of the image sensor 41. Thus, light passes through the infrared filter to reach the image sensor. In low light conditions, the infrared filter 49 is moved out of the light path of the image sensor so as to be out of the way. (In FIG. 2, the IR filter 49 is shown in solid lines out of the light path between the lens 25 and image sensor 41 and shown in dashed lines in the light path.) A motor 51 and a motor driver 53 move the infrared filter 49 in front of and out of the way of the image sensor. The motor driver 53 is connected to the CPU 39.

The camera, and if needed the flash 27, is triggered by the triggering, or trigger, sensors 29. In the preferred embodiment, the triggering sensors are motion sensors. A motion sensor senses an object moving in proximity to the camera. For example, an animal may move across the field of view of the camera, from one side to the other side. Motion sensors can be active or passive. Types of active motion sensors include ultrasonic and microwave sensors. One type of passive motion sensor is a passive infrared (PIR) sensor. In the preferred embodiment, the motion sensors are each a passive infrared (PIR) sensor, which are conventional and commercially available. A PIR sensor senses change in infrared light, which change is indicative of movement of an animal or person. Other types of motion sensors, for example ultrasonic, do not rely on infrared. Each PIR sensor is located behind a cover that is transparent to infrared. (FIGS. 1 and 2 show the cover in front of the sensor 29.) The PIR sensors 29 are connected to the CPU 39 by way of one or more drivers 55. An indicator light is provided on the front of the camera to illuminate when one or more of the PIR sensors 29 are affected by motion. This allows the PIR sensor operation to be tested and verified.

The camera has a display 35 for providing information. In the preferred embodiment, the display is a liquid crystal display (LCD). The LCD 35 is connected to the CPU 39 by way of an LCD driver 57. In the preferred embodiment, the display shows information such as the strength of the battery charge, the date and time, the number of pictures taken and the number of pictures remaining that can be stored with the available memory 43, 45. A power on button turns the display 35 on. The camera has a user input 59 in the form of several buttons for an operator to program the camera. The user can program various camera settings such as the clock time (including a 12 or 24 hour clock), the date, whether to take still pictures or video, number of still pictures to take after the camera is triggered, resolution of images taken, video length after triggering the camera, data and time, flash type (white light or infrared), sensitivity of the triggering sensor 29, operation times (all day, daylight or night), name of camera, etc. Many cameras provide default settings which the user can change. Other settings may include aperture, shutter speed, etc. These are all commands provided by, or revised by, the user, whether through the user interface or through the remote device 15. A temperature sensor 50 is also provided. A power supply, typically batteries, along with power control electronics, are also provided.

The camera 17 is mounted to support structure 13 (see FIG. 2) by way of a strap, bracket, etc. The structure 13 can be a tree, post, wall, stand, etc.

The camera has fast shutter activation. Digital cameras, such as manually operated cameras, have a time lag from when the shutter button is pressed to when the picture is taken. This time lag becomes apparent when taking a picture of fast changing or moving images. Although automatic cameras do not rely on a user pressing a shutter button to initiate camera operation, they nevertheless experience a time lag in taking pictures from when the triggering sensor detects a moving object to when the image is taken or captured and processed by the CPU 39. Part of the time lag can be attributed to power conservation measures. In order to conserve power, the CPU 39 is put into a “sleep” mode when not in use. When an image is to be taken, the CPU is “woken” so as to be ready to process the image data. In the sleep mode, the CPU consumes less power and is unable to process images. The sleep mode CPU however can process other inputs such as inputs from the triggering sensors 29. In the wake mode, the CPU can process images.

Referring to FIG. 3, there are provided plural triggering sensors 29 which are connected to one or more drivers 55. As previously discussed, the sensors 29 in the preferred embodiment are of the PIR type, passive infrared sensors.

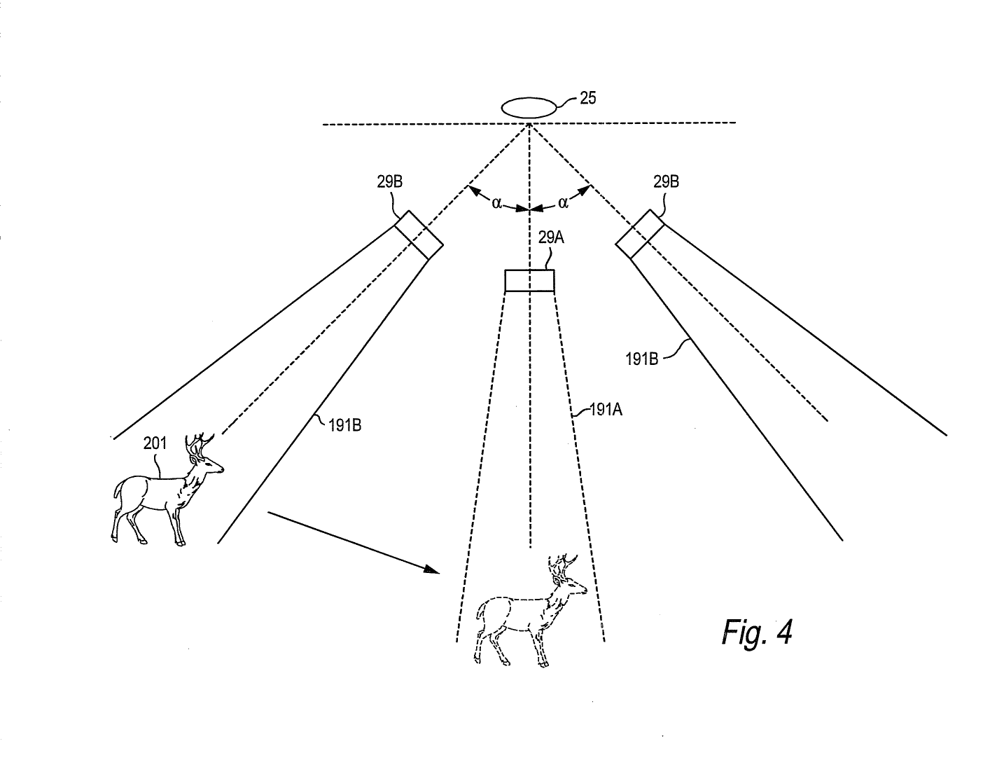

As shown in FIG. 4, among the triggering sensors, there is a main sensor 29A and one or more secondary sensors 29B. Each sensor 29A, 29B has a detecting angle (for example 10 to 20 degrees), that establishes a respective detection area 191A, 191B. When an object emitting infrared radiation enters the detection area 191, this is detected by the respective sensor. Fresnel lens are typically used to enlarge the detection angle.

The main sensor 29A is oriented so as to have its detection area 191A correspond to the preferred orientation of the camera lens. This would typically be directly in front of the camera lens 25. The secondary sensors 29B are oriented so as to have their respective detection areas 191B at some angle α relative to the main sensor so as to sense a different area than the main sensor. For example, as shown in FIG. 4, the main sensor 29A is directed straight out in front of the camera lens. There is a secondary sensor 29B on each side of the main sensor, with each oriented at 45 degrees to the main sensor. Thus, the secondary sensors 29B monitor areas 191B on each side of the main sensor 29A detection area 191A. As an alternative, only one secondary sensor can be used, for example if the camera were looking along an object such as a wall. The main sensor would have its detection area looking along the wall with the secondary sensor having its detection area out away from the wall. There would be no need to have a secondary sensor directed toward the wall as no object could pass through the wall. As another alternative, a secondary sensor can be provided with a detection area that is above the detection area of the main sensor so as to detect any flying objects such as birds.

The detection areas 191A, 191B of the sensors are oriented so that the time lag for a typical object to cross from the secondary sensor detection area 191B to the main sensor detection area 191A is the same as or longer than the wake up period for the CPU. For example, if the camera is designed to detect wildlife at a feeder, such wildlife typically walks. However, if the objects move faster than walking speed, such as running, then the secondary sensor or sensors 29B can be oriented at a greater angle α. The angle α can be chosen for a “worst case”, such as a fast moving or running object.

As an object 201 (for example an animal, a person, etc.) moves across the area in front of the camera, it enters a detection area 191B and is first sensed by a secondary sensor 29B. As the object 201 (shown by dashed lines in FIG. 4) keeps moving across the camera field, it enters the main detection area 191A and is sensed next by the main sensor 29A.

Following some period of time after a picture has been taken, the CPU 39 (see FIG. 3) is put into a sleep mode in order to conserve power. When the next picture is taken, the CPU is woken up. The camera uses the secondary sensor or sensors 29B to wake up the CPU. The main sensor 29A is used to trigger the camera CPU to take the picture.

Referring to the example shown in FIG. 4, when the object 201 moves into the sensing area 191B of one of the secondary sensors 29B, the secondary sensor sends a signal to wake up the CPU. The CPU 39 wakes up and is ready to process and record the image from the image sensor 41. When the object moves into the sensing area 191A of the main sensor 29A, the main sensor produces a signal that causes the CPU 39 to take the picture immediately. Little or no time is lost powering up the CPU to take a picture.

The fast shutter feature allows the camera to capture pictures of wildlife or other objects that move rapidly across the detection area of the camera. The fast shutter feature can be used on any type of camera that has a slow-starting processor or other slow starting component that adds delay in taking an image. Thus, the fast shutter feature allows the use of power conservation techniques without sacrificing camera performance in capturing moving objects. In addition, the fast shutter feature also allows the use of less expensive camera electronics while maintaining performance in capturing moving objects.

The foregoing disclosure and showings made in the drawings are merely illustrative of the principles of this invention and are not to be interpreted in a limiting sense.

1. A surveillance camera, comprising:
a) a lens;
b) a memory;
c) an image sensor;
d) a processor that processes information from the image sensor, the processor operates in a sleep mode, wherein the processor cannot process information from the image sensor, and a wake mode, wherein the processor can process information from the image sensor;
e) first and second triggering sensors that each have a detection area, the first triggering sensor detection area located in front of the lens, the second triggering sensor detection area located adjacent to the first triggering sensor detection area, wherein when the second triggering sensors senses an object moving in its respective detection area, the second triggering sensor causes the processor to enter the wake mode, and when the first triggering sensor senses an object moving in its respective detection area, the first triggering sensor causes the processor to capture and process an image.

2. The surveillance camera of claim 1, wherein the second triggering sensor detection area is located to a side of the first triggering sensor detection area.

3. The surveillance camera of claim 2, further comprising a third triggering sensor having a third detection area located to another side of the first triggering sensor detection area, wherein when the third triggering sensor senses an object moving in its respective detection area, the third triggering sensor causes the processor to enter the wake mode.

4. The surveillance camera of claim 3, wherein the first, second and third triggering sensors are each passive infrared sensors.

5. A method of taking images with a surveillance camera, comprising the steps of:
a) providing first and second triggering sensors, each having a respective detection area;
b) providing a processor that can process images;
c) operating the processor in a sleep mode;
d) detecting an object entering the second triggering sensor detection area;
e) upon detecting the object entering the second triggering sensor detection area, changing the operation of the processor from the sleep mode to a wake mode;
f) detecting the object entering the first triggering sensor detection area;
g) upon detecting the object entering the first triggering sensor detection area, taking an image and processing the image with the processor in the wake mode.
